(19) United States
(12) Patent Application Publication
(10) Pub. No.: US 2024/0292327 A1
(43) Pub. Date: Aug. 29, 2024

(54) POWER SAVE IN OVERLOADED WIRELESS TRANSMISSIONS

(71) Applicant: Apple Inc., Cupertino, CA (US)

(72) Inventors: Lochan VERMA, Danville, CA (US); Yong LIU, Campbell, CA (US); Tianyu WU, Monterey, CA (US)

(73) Assignee: Apple Inc., Cupertino, CA (US)

(21) Appl. No.: 18/437,642

(22) Filed: Feb. 9, 2024

Related U.S. Application Data
(60) Provisional application No. 63/448,919, filed on Feb. 28, 2023.

(51) Int. Cl. H04W 52/02

(52) U.S. Cl. CPC H04W 52/0225

(57) ABSTRACT

Some aspects of this disclosure include apparatuses and methods for implementing power consumption mitigation techniques for downlink transmission of a high priority payload in wireless communication networks. For example, an electronic device includes a transceiver and a processor. The processor is configured to receive, using the transceiver and from a second electronic device, a preamble associated with a first payload. The processor is further configured to determine, based at least on the preamble, that a second payload is to be received. The processor is further configured to receive, from the second electronic device, an overload marker symbol (OMS) and determine, based at least on the OMS, whether the second payload is to be received following the OMS. The processor is further configured to transition the transceiver to, or maintain the transceiver in, an awake state in response to determining that the second payload is to be received following the OMS.

### CROSS-REFERENCE TO RELATED APPLICATIONS

The present application claims the benefit of U.S. Provisional Patent Application No. 63/448,919, filed on Feb. 28, 2023, which is incorporated by reference herein in its entirety.

### BACKGROUND

### Field

The described aspects generally relate to transmission of a high priority payload in wireless communications. For example, aspects of this disclosure relate to power consumption mitigation techniques and delay reduction in downlink transmission of the high priority payload in wireless communication networks, such as a wireless local area network (WLAN).

### Related Art

When an access point (AP) receives one or more high priority (HP) packets while no downlink (DL) transmission is ongoing, the AP can transmit the HP packet(s) in the next earliest transmission opportunity (e.g., with a delay of at least one channel access time). However, if a DL transmission is ongoing, the AP can transmit the HP packet(s) in the next earliest transmission opportunity (e.g., with a delay of at least the current DL packet(s) transmission time and one channel access time).

### SUMMARY

Some aspects of this disclosure include a system, apparatus, article of manufacture, method, and/or computer program product and/or combinations and/or sub-combinations thereof, for implementing power consumption mitigation techniques for transmission and reception of high priority payload in wireless communication networks, such as a wireless local area network (WLAN). The power consumption mitigation techniques for downlink transmission of high priority payload can assist devices in the WLAN (e.g., an access point (AP), a station (STA), etc.) to use overload techniques to reduce the delays in transmitting high priority (HP) payload while improving the power consumption of the receiving HP STA(s).

Some aspects of this disclosure relate to an electronic device. The electronic device includes a transceiver configured to communicate using a wireless network and a processor communicatively coupled with the transceiver. The processor is configured to receive, using the transceiver and from a second electronic device, a preamble associated with a first payload. The processor is further configured to determine, based at least on the preamble, that a second payload is to be received. The processor is further configured to receive, from the second electronic device, an overload marker symbol (OMS) and determine, based at least on the OMS, whether the second payload is to be received following the OMS. The processor is further configured to operate the transceiver in an awake state in response to determining that the second payload is to be received following the OMS.

In some aspects, the processor is further configured to transition the transceiver to a lower power state than the awake state after receiving the preamble.

In some aspects, the OMS is one symbol in a plurality of periodic OMSs and the processor is further configured to determine an OMS interval between two consecutive OMSs in the plurality of periodic OMSs and transition the transceiver from the lower power state to the awake state before the next occurrence of an OMS of the plurality of periodic OMSs.

In some aspects, operating the transceiver in the awake state further includes maintaining the transceiver in the awake state in response to determining that the second payload is to be received after the OMS and transitioning the transceiver to the lower power state after receiving the second payload. In some aspects, the OMS includes an identifier of the electronic device.

In some aspects, the OMS is an opportunistic OMS. To receive the opportunistic OMS, the processor is further configured to transition a receive-only receiver of the electronic device to the awake state and receive, using the receive-only receiver, the opportunistic OMS.

In some aspects, the processor is further configured to transition the transceiver from the lower power state to the awake state in response to determining that the second payload is to be received after the opportunistic OMS. The processor is further configured to transition the transceiver to the lower power state after receiving the second payload. In some aspects, the processor is further configured to transition the receive-only receiver to the lower power state after receiving the opportunistic OMS.

In some aspects, the opportunistic OMS includes an identifier of the electronic device and a duration of the opportunistic OMS equals a duration of a high efficiency (HE) data symbol.

Some aspects of the disclosure relate to a method including receiving, using a transceiver of a first electronic device and from a second electronic device, a preamble associated with a first payload. The method further includes determining, based at least on the preamble, that a second payload is to be received. The method also includes receiving, from the second electronic device, an overload marker symbol (OMS) and determining, based at least on the OMS, whether the second payload is to be received following the OMS. The method further includes operating the transceiver in an awake state in response to determining that the second payload is to be received following the OMS and receiving, using the transceiver, the second payload.

Some aspects of the disclosure relate to a non-transitory computer-readable medium storing instructions that, when executed by a processor of a first electronic device, cause the processor to perform operations including receiving, using a transceiver of the first electronic device and from a second electronic device, a preamble associated with a first payload. The operations further include determining, based at least on the preamble, that a second payload is to be received. The operations also include receiving an overload marker symbol (OMS) and determining, based on the OMS, whether the second payload is to be received following the OMS. The operations further include operating the transceiver in an awake state in response to determining, based at least on the OMS, that the second payload is to be received following the OMS and receiving, using the transceiver, the second payload.

Some aspects of this disclosure relate to an electronic device. The electronic device includes a transceiver configured to communicate using a wireless network and a processor communicatively coupled with the transceiver. The processor is configured to receive, using the transceiver and from a second electronic device, a preamble associated with a first payload. The processor is further configured to determine, based at least on the preamble, that a second payload is to be received. The processor is further configured to determine whether the second payload is received within a timeout period and transition the transceiver to a lower power state than an awake state in response to determining that the second payload is not received within the timeout period.

Some aspects of this disclosure relate to a method including receiving, using a transceiver of a first electronic device and from a second electronic device, a preamble associated with a first payload. The method further includes determining, based at least on the preamble, that a second payload is to be received. The method also includes determining whether the second payload is received within a timeout period and transitioning the transceiver to a lower power state than an awake state in response to determining that the second payload is not received within the timeout period.

Some aspects of the disclosure relate to a non-transitory computer-readable medium storing instructions that, when executed by a processor of a first electronic device, cause the processor to perform operations including receiving, using a transceiver of the first electronic device and from a second electronic device, a preamble associated with a first payload. The operations further includes determining, based at least on the preamble, that a second payload is to be received. The operations also include determining whether the second payload is received within a timeout period and transitioning the transceiver to a lower power state than an awake state in response to determining that the second payload is not received within the timeout period.

This Summary is provided for purposes of illustrating some aspects of the disclosure to provide an understanding of the subject matter described herein. Accordingly, the above-described features are examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing power consumption mitigation techniques for downlink transmission of high priority payload in a communication network, according to some aspects.

FIG. 2 illustrates a block diagram of an example wireless system of an electronic device implementing the power consumption mitigation techniques for downlink transmission of high priority payload in a communication network, according to some aspects.

FIG. 3 illustrates an example of communication between an access point (AP) and a high priority (HP) station (STA) for the power consumption mitigation techniques for the downlink (DL) transmission of HP packets using a timeout period, according to some aspects.

FIG. 4 illustrates an example of communication between an AP, an HP STA, and a low priority (LP) STA for the power consumption mitigation techniques for the DL transmission of the HP packets using periodic overload marker symbols (OMSs), according to some aspects.

FIG. 5 illustrates an example of communication between an AP, an HP STA, and an LP STA for the power consumption mitigation techniques for the DL transmission of the HP packets using opportunistic OMS, according to some aspects.

FIG. 6A illustrates an example design of an opportunistic OMS, according to some aspects of the disclosure.

FIG. 6B illustrates an example design of a multi user (MU) Physical Layer Protocol Data Unit (PPDU) with opportunistic OMS, according to some aspects of the disclosure.

FIG. 7A illustrates an example method for a wireless system (e.g., an HP STA) supporting and implementing the power consumption mitigation techniques for the DL transmission of HP packets using a timeout period, according to some aspects.

FIG. 7B illustrates an example method for a wireless system (e.g., an AP) supporting and implementing the power consumption mitigation techniques for the DL transmission of HP packets using a timeout period, according to some aspects.

FIG. 8A illustrates an example method for a wireless system (e.g., an HP STA) supporting and implementing the power consumption mitigation techniques for the DL transmission of the HP packets using OMSs, according to some aspects.

FIG. 8B illustrates an example method for a wireless system (e.g., an AP) supporting and implementing the power consumption mitigation techniques for the DL transmission of the HP packets using OMSs, according to some aspects.

FIG. 9 illustrates an example computer system that can implement some aspects of the disclosure or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure include apparatuses and/or methods for implementing power consumption mitigation techniques for downlink transmission of high priority payload in wireless communication networks, such as a wireless local area network (WLAN). The power consumption mitigation techniques for downlink transmission of high priority payload can assist devices in the WLAN (e.g., an access point (AP), a station (STA), etc.) to use overload techniques to reduce the delays in transmitting a high priority (HP) payload while improving (e.g., reducing) the power consumption of the receiving HP STA(s).

According to some aspects, the power consumption mitigation techniques for downlink transmission of a high priority payload in a WLAN can be implemented with communication techniques compatible with Institute of Electrical and Electronics Engineers (IEEE) 802.11 standards (such as, but not limited to, IEEE 802.11ac, IEEE 802.11ax, IEEE 802.11bc, IEEE 802.11bd, IEEE 802.11be, etc.). For example, the power consumption mitigation techniques for downlink transmission of a high priority payload in a WLAN can be implemented using a WiFi protocol, such as Wi-Fi™ 6, Wi-Fi™ 7, Wi-Fi™ 8, or other Wi-Fi™ based on IEEE 802.11 WLAN standards. However, aspects of this disclosure can also be applied to operations in other communication networks operating in accordance with any protocol(s).

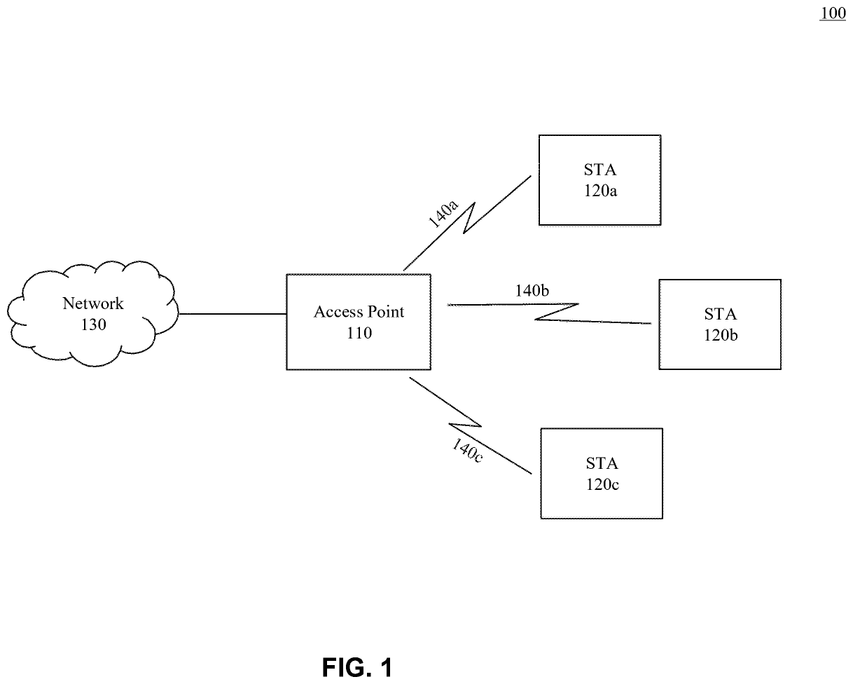

FIG. 1 illustrates an example system 100 implementing the power consumption mitigation techniques for downlink transmission of a high priority payload in a communication network (such as, but not limited to, a multi-link communication network), according to some aspects. Example system 100 is provided for the purpose of illustration only and does not limit the disclosed aspects.

System 100 can include, but is not limited to, access point (AP) 110, stations (STAs) 120, and network 130. In some examples, the AP 110 can be an AP multi-link device (MLD) and the STAs 120 can non-AP MLDs. The STAs 120a-120c can include, but are not limited to, WLAN electronic devices such as wireless communication devices, smart phones, laptops, desktops, tablets, personal assistants, monitors, televisions, wearable devices, gaming devices, Internet of Thing (IoT) devices, and the like. The AP 110 can include, but is not limited to, a WLAN electronic device such as an access point, a wireless router, a wearable device (e.g., a smart watch), a wireless communication device (e.g., a smart phone), a gaming device, or any combination thereof. Network 130 can be the Internet and/or a WLAN. The STA 120's communications are shown as wireless communications 140. The communication between the AP 110 and the STA 120 can take place using wireless communications 140a-140c. The wireless communications 140a-140c can be based on a wide variety of wireless communication techniques. These techniques can include, but are not limited to, techniques based on IEEE 802.11 (such as, but not limited to IEEE 802.11ac, IEEE 802.11ax, IEEE 802.11bc, IEEE 802.11bd, IEEE 802.11be, IEEE 802.11v, etc. standards).

According to some aspects, the system 100 can include a multi-link communication network. For example, the AP 110 and one or more of the STAs 120 are configured to implement multi-link communication. In other words, the AP 110 and the STAs 120 are configured to implement and support simultaneous or substantially simultaneous data transfer using multiple MAC/PHY links. However, aspects of this disclosure can also be applied to operations in other communication networks.

According to some aspects, one or more of the STAs 120 can include low priority (LP) STAs. The LP STAs are configured to receive and/or transmit LP packet(s) (also referred to herein as LP payload). Additionally, or alternatively, one or more of the STAs 120 can include high priority (HP) STAs. The HP STAs are configured to receive and/or transmit HP packet(s) (also referred to herein as HP payload). In some implementations, the HP packet(s) can be associated with, e.g., a latency sensitive application, such as video application(s) providing video communications, interactive play (such as but not limited to, virtual reality (VR), augmented reality (AR)), and the like. In some implementations, the HP packet(s) can be associated with audio communications. In still other implementations, the HP packet(s) can be associated with industrial uses that require low latency communication. Other implementations and/or applications of HP packets also are possible, such as any application requiring a certain quality of service. However, aspects of this disclosure are not limited to the presented examples and aspects of this disclosure can be applied to other examples of HP packets and/or low latency communications. Further, in some implementations, the LP packets can be associated with communications that do not require low latency. For example, in some implementations, the LP packets can be associated with applications such as web browsing, file transfer, and the like.

According to some aspects, an HP packet can be a packet with an associated latency requirement that is smaller than a first threshold. Similarly, an LP packet can be a packet with an associated latency requirement that can be greater than a second threshold.

As a non-limiting example, the STA 120a is an LP STA and the STA 120b is an HP STA. The AP 110 receives one or more HP packets that are addressed to the STA 120b. For example, the AP 110 receives the one or more HP packets from the STA 120c. According to some aspects, when the AP 110 has no ongoing downlink (DL) transmission, the AP 110 will send the received one or more HP packets in the next earliest transmission opportunity. For example, the AP 110 can contend for the communication channel, and when successful, the AP 110 can transmit the one or more HP packets to the STA 120b.

According to some aspects, when the AP 110 has an ongoing DL transmission, the AP 110 will send the received one or more HP packets in the next earliest transmission opportunity after the current DL transmission is completed. For example, the AP 110 can contend for the communication channel after the current DL transmission is completed. When the AP 110 is successful in reserving the communication channel, the AP 110 can transmit the one or more HP packets to the STA 120b.

According to some aspects, when the AP 110 has an ongoing DL transmission, the AP 110 will send the received one or more HP packets with the current ongoing DL transmission. In some examples, the ongoing DL transmission can be a DL transmission of LP packet(s) and the AP 110 will send the received one or more HP packets with the LP packet(s). In this example, the AP 110 can reduce the delay in transmitting the received HP packet(s) by avoiding the delay in waiting to finish the ongoing DL transmission and the delay in accessing the communication channel. According to some aspects, the AP 110 can transmit the HP packet(s) with the ongoing DL transmission of the LP packet(s) using one or more of Opportunistically Overloaded Resource Unit (O2RU), Physical Layer Protocol Data Unit (PPDU) preemption, concatenated PPDU (CPPDU), or the like.

According to some aspects, in the O2RU method, Medium Access Control (MAC) Protocol Data Units (MPDUs) belonging to multiple receivers and to different Traffic Identifiers (TIDs) can be carried in an Aggregated MPDU (AMPDU) on an RU. According to some aspects, in the PPDU preemption, the AP 110 can preempt the current PPDU transmission carrying the LP packets, and the AP 110 can start a new PPDU carrying the HP packets. According to some aspects, in the CPPDU, the AP 110 can append the new PPDU carrying the HP packets to the end of the current PPDU transmission that carries the LP packets.

However, aspects of this disclosure are not limited to these examples, and the AP 110 also can use other methods to transmit the one or more HP packets that the AP 110 receives while the DL transmission of LP packet(s) is ongoing.

In some examples, when the AP 110 is using overloading or preemption for the DL transmission of the HP packet(s) during the DL transmission of the LP packet(s), the HP STAs (e.g., STA 120b) need to be awake during the DL transmission of the LP packet(s) (even when the DL transmission of the LP packet(s) is not overloaded/preempted), which would result in high power consumption by the HP STA(s).

Some aspects of this disclosure are directed to power consumption mitigation techniques for the DL transmission of the HP packets when the DL transmission of the LP packet(s) is overloaded or preempted (e.g., O2RU, PPDU preemption, CPPDU, or the like) by the HP packet(s). In some aspects, for overloading the DL transmission of the LP packet(s), some or all of the LP payload in an ongoing LP PPDU is replaced with the HP payload. In some aspects, for preempting the DL transmission of the LP packet(s), the ongoing LP PPDU is terminated and the HP PPDU transmission follows the terminated LP PPDU immediately without Enhanced Distributed Channel Access (EDCA). As discussed in more detail below, the HP STAs (e.g., STA 120b) need not process all LP packet(s) (e.g., LP PPDUs) to determine whether the LP packet(s) is overloaded or preempted by the HP packet(s), even though the preemption is indicated in the preamble of the LP packet(s) by the AP 110. Therefore, the power consumption of the HP STAs (e.g., HP STA 120b receiving the HP packet(s)) can be improved.

According to some aspects, the AP 110 can use a timeout period for the power consumption mitigation associated with the DL transmission of the HP packets when the DL transmission of the LP packet(s) is overloaded or preempted. As discussed in more detail below, the AP 110 can limit the start of the overloading and/or the preempting event by the timeout period relative to the start of the DL transmission of the LP packet(s). In some examples, the HP STA 120b can stop the receipt of the LP packet(s) when no HP packet reception begins before the expiration of the timeout period. The use of the timeout period for power consumption mitigation can be applied to DL single user (SU) PPDUs and/or to DL multi-user (MU) PPDUs. In some examples, the HP STA 120b can be a Wi-Fi™ 8 STA and the LP STA 120a can be a Wi-Fi™ 6/7/8 STA.

According to some aspects, the AP 110 can use one or more overload marker symbols (OMSs) to indicate whether the DL transmission of the LP packet(s) is overloaded with or preempted by HP packets. As discussed in more detail below, the AP 110 can insert an OMS in the DL transmission of the LP packet(s) to indicate whether HP packet(s) will follow the OMS. In some aspects, the OMSs are periodic OMSs. A periodic OMS inserted into the DL transmission of the LP packet(s) can indicate the presence/absence of an immediately following overloading/preempting event. The HP STA 120b can put its transceiver (e.g., its main radio) into a lower power state, e.g., a sleep state, between periodic OMSs when a periodic OMS indicates that no HP packet(s) will follow the periodic OMS. The HP STA 120b can transition its transceiver to a higher power state, e.g., an awake state, periodically to receive the periodic OMSs. When the periodic OMS indicates a presence of an immediately following overload/preempted event, the HP STA 120b can keep its transceiver in the awake state. Otherwise, the HP STA 120b can transition its transceiver to the sleep state until the next periodic OMS occurrence in the DL transmission of the LP packet(s).

According to some aspects, the OMSs are opportunistic OMSs, and the AP 110 can use one or more opportunistic OMSs to indicate whether the DL transmission of the LP packet(s) is overloaded with or preempted by HP packets. As discussed in more detail below, the AP 110 can insert the opportunistic OMSs in the DL transmission of the LP packet(s) to indicate that the HP packet(s) will follow the opportunistic OMS. In other words, the AP 110 inserts the opportunistic overload marker symbol into the DL transmission of the LP packet(s) when an overload/preempt event will follow. The HP STA 120b can put its transceiver into a lower power state and use a receive-only receiver (e.g., a scan radio) to detect the opportunistic OMS. The HP STA 120b can use its receive-only receiver to listen for the opportunistic OMS. The HP STA 120b can transition its transceiver (e.g., its main radio) to an awake state when the HP STA 120b detects (using its receive-only receiver) the opportunistic OMS and the HP STA 120b determines that one or more HP packets will follow the opportunistic OMS. During the time period that the HP STA 120b is receiving the HP packet(s) using the transceiver, the HP STA 120b can transition its receive-only receiver to the lower power state, e.g., sleep state. Additionally, or alternatively, the HP STA 120b can transition its receive-only receiver to operate on different channels (e.g., different frequencies). After the HP STA 120b receives the HP packet(s), the HP STA 120b can transition its transceiver to the sleep state and can transition its receive-only receiver to the awake state (or to the channel/RU on which the DL transmission of the LP packet(s) is occurring).

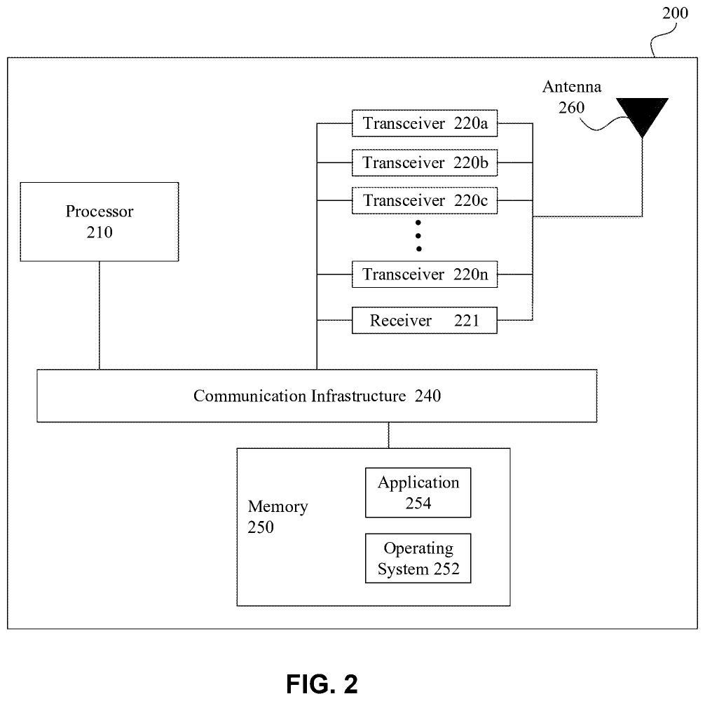

FIG. 2 illustrates a block diagram of an example device 200 (e.g., a wireless electronic device) implementing the power consumption mitigation techniques for downlink transmission of a high priority payload in a communication network, according to some aspects. Device 200 can be any of the electronic devices (e.g., AP 110, STA 120) of system 100. Device 200 includes processor 210, one or more transceivers 220a-220n, one or more receiver(s) 221, communication infrastructure 240, memory 250, operating system 252, application 254, and one or more antennas 260. Illustrated parts are provided as exemplary parts of the device 200, and the device 200 can include other circuit(s) and subsystem(s). Also, although the systems of device 200 are illustrated as separate components, aspects of this disclosure can include any combination of these components, fewer components, more components, and/or different components.

The memory 250 can include random access memory (RAM) and/or cache, and can include control logic (e.g., computer software) and/or data. The memory 250 can include other storage devices or memory such as, but not limited to, a hard disk drive and/or a removable storage device/unit. According to some examples, the operating system 252 can be stored in the memory 250. The operating system 252 can manage transfer of data from the memory 250 and/or one or more applications 254 to the processor 210, the one or more transceivers 220a-220n, and/or the one or more receiver(s) 221. In some examples, the operating system 252 maintains one or more network protocol stacks (e.g., Internet protocol stack, cellular protocol stack, and the like) that can include a number of logical layers. At corresponding layers of the protocol stack, the operating system 252 includes control mechanism and data structures to perform the functions associated with that layer.

According to some examples, the application 254 can be stored in the memory 250. The application 254 can include applications (e.g., user applications) used by the device 200 and/or a user of the device 200. The applications in the application 254 can include applications such as, but not limited to, audio/video communication applications, radio streaming, video streaming, remote control, gaming application(s), and/or other user applications.

Device 200 can also include the communication infrastructure 240. The communication infrastructure 240 provides communication between, for example, the processor 210, the one or more transceivers 220a-220n, the one or more receiver(s) 221, and the memory 250. In some implementations, the communication infrastructure 240 can be a bus. The processor 210 together with instructions stored in the memory 250 performs operations enabling the device 200 of the system 100 to implement the power consumption mitigation techniques for downlink transmission of a high priority payload as described herein. Additionally, or alternatively, the one or more transceivers 220a-220n and/or the one or more receiver(s) 221 perform operations enabling the device 200 of system 100 to implement the power consumption mitigation techniques for downlink transmission of a high priority payload as described herein.

The one or more transceivers 220a-220n transmit and receive communications signals that support the power consumption mitigation techniques for downlink transmission of a high priority payload, according to some aspects, and can be coupled to the one or more antennas 260. The one or more auxiliary radios (or, receiver(s)) 221 receive communications signals that support the power consumption mitigation techniques for downlink transmission of a high priority payload, according to some aspects, and can be coupled to the one or more antennas 260. (Herein, transceivers can also be referred to as radios). The antenna 260 can include one or more antennas that can be the same or different types.

The one or more transceivers 220a-220n and/or the one or more receiver(s) 221 allow device 200 to communicate with other devices that can be wired and/or wireless. In some examples, the one or more transceivers 220a-220n can include processors, controllers, radios, sockets, plugs, buffers, and like circuits/devices used for connecting to and communication on networks. According to some examples, the one or more transceivers 220a-220n include one or more circuits to connect to and communicate on wired and/or wireless networks.

According to some aspects of this disclosure, the one or more transceivers 220a-220n can include a cellular subsystem, a WLAN subsystem, and/or a Bluetooth™ subsystem, each including its own radio transceiver and protocol(s) as will be understood by those skilled arts based on the discussion provided herein. In some implementations, the one or more transceivers 220a-220n can include more or fewer systems for communicating with other devices.

In some examples, the one or more transceivers 220a-220n can include one or more circuits (including a cellular transceiver) for connecting to and communicating on cellular networks. The cellular networks can include, but are not limited to, 4G/5G/6G networks such as Universal Mobile Telecommunications System (UMTS), Long-Term Evolution (LTE), and the like.

Additionally, or alternatively, the one or more transceivers 220a-220n can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 220n can include a Bluetooth™ transceiver.

Additionally, the one or more transceivers 220a-220n can include one or more circuits (including a WLAN transceiver) to enable connection(s) and communication over WLAN networks such as, but not limited to, networks based on standards described in IEEE 802.11 (such as, but not limited to IEEE 802.11ac, IEEE 802.11ax, IEEE 802.11bc, IEEE 802.11bd, IEEE 802.11be, etc.). For example, the transceiver 220a can enable connection(s) and communication over a WLAN (e.g., a multi-link WLAN) having a first link associated with 2.4 GHz wireless communication channel. For example, the transceiver 220b can enable connection(s) and communication over the WLAN having a second link associated with 5 GHz wireless communication channel. For example, the transceiver 220c can enable connection(s) and communication over the WLAN having a third link associated with 6 GHz wireless communication channel. However, aspects of this disclosure are no limited to these wireless channels and other PHY layer links and/or other wireless channels can be used.

Additionally, or alternatively, the device 200 can include one WLAN transceiver configured to operate at two or more links. The processor 210 can be configured to control the one WLAN transceiver to switch between different links, according to some examples. For example, the transceiver 220a can enable connection(s) and communication over a WLAN having a first link associated with 2.4 GHz wireless communication channel. And the transceiver 220b can enable connection(s) and communication over the WLAN having a second link associated with 5 GHz wireless communication channel and can enable connection(s) and communication over the WLAN having a third link associated with 6 GHz wireless communication channel. According to some aspects, the switching from the first link to the second link can include using a transceiver (e.g., the transceiver 220b) associated with the second link instead of the transceiver (e.g., the transceiver 220a) associated with the first link. Additionally, or alternatively, the switching from the first link to the second link can include controlling a single transceiver (e.g., the transceiver 220a) to operate at the frequency of the second link instead of operating at the frequency of the first link.

According to some aspects, device 200 can optionally include the one or more receiver(s) 221. In some examples, the receiver 221 can be a receive-only receiver, for example, a receive-only auxiliary radio. In a non-limiting example, the receiver 221 can be a scan radio. In some examples, the receiver 221 can be a low power radio that can scan through each channel(s) of a frequency band/link and listen for per channel dwell time. Additionally, or alternatively, the receiver 221 can obtain statistics indicating a corresponding channel quality. The receiver 221 can repeat such operation every scan interval. In another non-limiting example, the receiver 221 can be a non-scanning radio used for non-scanning purposes. In one example, the device 200 can include one receiver 221, which can scan channels in a 2.4 GHz band, in a 5 GHz band, and/or in a 6 GHz band. Alternatively, the device 200 can include more than one receiver 221, where a first receiver can scan channels in a 2.4 GHz band and a second receiver can scan in a 5 GHz band and/or in a 6 GHz band. Alternatively, the device 200 can include more than one receiver 221, where a first receiver can scan channels in a 2.4 GHz band, and a second receiver can scan in a 5 GHz band, and a third receiver can scan in a 6 GHz band. In other examples, the receiver 221 is an auxiliary radio that is a receiver only but can be turned into a transceiver by moving radio resource(s) from the transceiver 220 to the receiver 221. However, these are provided as examples, and aspects of this disclosure can include other number of receivers, frequency bands, and/or configurations. In some examples, the one or more receiver(s) 221 can include processors, controllers, radios, sockets, plugs, buffers, and like circuits/devices used for scanning on networks.

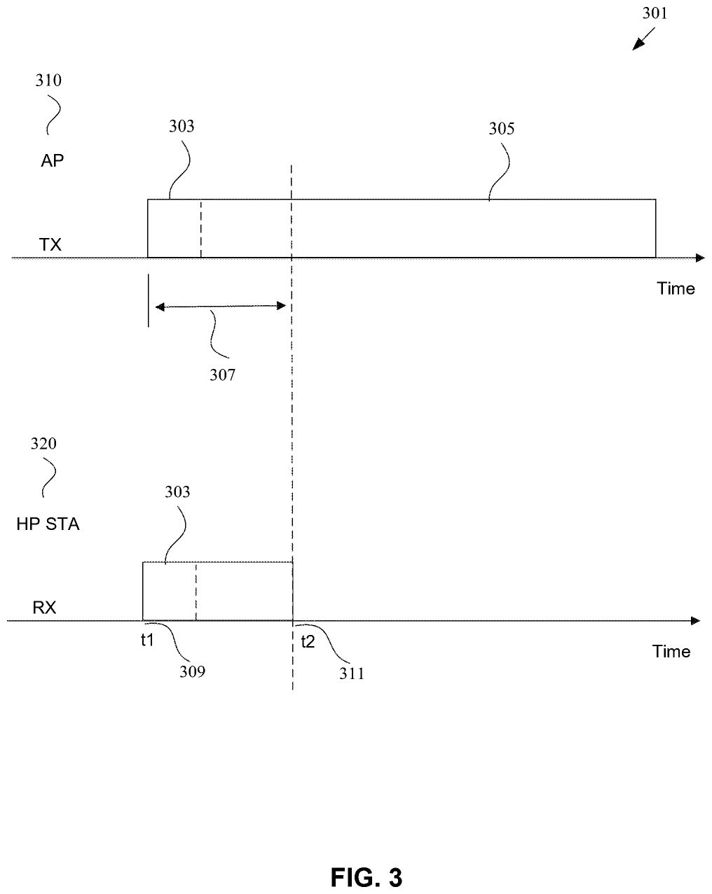

According to some aspects of this disclosure, the processor 210, alone or in combination with computer instructions stored within the memory 250, the one or more transceiver 220a-220n, and/or the one or more receiver(s) 221 implements the power consumption mitigation techniques for downlink transmission of a high priority payload as discussed herein. As discussed in more detail below with respect to FIGS. 3-8, the processor 210 can implement the power consumption mitigation techniques for downlink transmission of a high priority payload of FIGS. 1 and 2.

FIG. 3 illustrates an example of communication between an AP and an HP STA for the power consumption mitigation techniques for the DL transmission of the HP packets using a timeout period, according to some aspects. As a convenience and not a limitation, FIG. 3 can be described with regard to elements of FIGS. 1-2.

FIG. 3 illustrates communication 301 between AP 310 and the HP STA 320. The AP 310 can be the AP 110 of FIG. 1. The HP STA 320 can be the HP STA 120b of FIG. 1. The AP 310 transmits one or more LP packets. The one or more LP packets can include preamble 303 and payload 305. According to some aspects, the AP 310 can use the preamble 303 to indicate that the DL transmission (e.g., the payload 305) can include one or more HP packets. For example, the preamble 303 can include one or more signaling bits for indicating that the payload 305 can include HP packet(s). The AP 310 can set the one or more signaling bits to indicate that the payload 305 can include HP packet(s).

According to some aspects, the AP 310 can use the timeout period 307 to determine whether to transmit HP packet(s) with the DL transmission of the LP packet(s) (e.g., the payload 305). The timeout period 307 can be calculated from the beginning of the preamble 303. When the AP 310 receives HP packet(s) within the timeout period 307 (not shown), the AP can transmit one or more of the received HP packet(s) within the payload 305. For example, the AP 310 can overload and/or preempt the payload 305 with the one or more received HP packet(s). For example, the AP 310 can overload and/or preempt one or more Physical Layer Service Data Units (PSDUs) in the payload 305 with one or more of the HP packets intended for the HP STA 320. In some implementations, the AP 310 can transmit all of the HP packet(s) in a single overload instance of the payload 305. Further, the payload 305 can include one or more PPDUs.

When the AP 310 does not receive one or more HP packet(s) within the timeout period 307, the AP will not transmit any HP packet(s) within the payload 305.

According to some aspects, the AP 310 can use the timeout period 307 for determining whether the AP 310 receives one or more HP packet(s) within the timeout period 307 when the length of the payload 305 (or the length of the preamble 303 and the payload 305) is greater than a threshold. For example, the AP 310 can compare the length of the payload 305 (or the length of the preamble 303 and the payload 305) with a threshold (e.g., threshold value). When the length of the payload 305 (or the length of the preamble 303 and the payload 305) is greater than or equal to a threshold, the AP 310 can use the timeout period 307 for determining whether the AP 310 receives one or more HP packet(s) within the timeout period 307. When the length of the payload 305 (or the length of the preamble 303 and the payload 305) is less than a threshold, the AP 310 does not use the timeout period 307. The length of the preamble 303 and the length of the payload 305 can be indicated in the preamble 303. When the length of the payload 305 or the length of the preamble 303 and the payload 305 are long enough (e.g., satisfies a threshold value), then the respective durations can support subsequent transmission of one or more HP packets. Consequently, the AP 310 can use the timeout period 307 to determine whether the one or more HP packets are received.

The HP STA 320 transitions its transceiver (e.g., a main radio) from the lower power state (e.g., sleep state) to the higher power state (e.g., awake state) at time t1 309 to receive the preamble 303. The HP STA 320 can detect, using the one or more signaling bits of the preamble 303, whether the payload 305 include one or more HP packets. The HP STA 320 will keep its transceiver in the awake state during the timeout period 307. When the HP STA 320 receives no HP packet(s) during the timeout period 307, the HP STA 320 can transition its transceiver to the sleep state at time t2 311. However, when the HP STA 320 receives one or more HP packets during the timeout period 307, the HP STA 320 can maintain its transceiver in the awake state until the HP packet(s) are received. After the HP STA 320 receives the HP packet(s), the HP STA 320 can transition its transceiver to the sleep state.

The use of the timeout period 307 for the power consumption mitigation can be applied both to DL single user (SU) PPDUs and to DL multi user (MU) PPDUs. In some examples, the HP STA 320 can be a Wi-Fi™ 8 STA (e.g., a STA compatible with 802.11bn) and the LP STA 120a can be Wi-Fi™ 6/7/8 STA (e.g., a STA compatible with 802.11ax, 802.11be, and/or 802.11bn).

According to some aspects, the value of the timeout period 307 can be included in the preamble 303. Additionally, or alternatively, the AP 310 can communicate the value of the timeout period 307 to the HP STA 320 during connection establishment between the AP 310 and the HP STA 320. Additionally, or alternatively, the AP 310 can communicate the value of the timeout period 307 to the HP STA 320 using one or more beacons. The value of the timeout period 307 can be stored in a memory (e.g., the memory 250) of the HP STA 320. However, aspects of this disclosure are not limited to these examples, and the AP 310 can communicate the value of the timeout period 307 to the HP STA 320 using other methods.

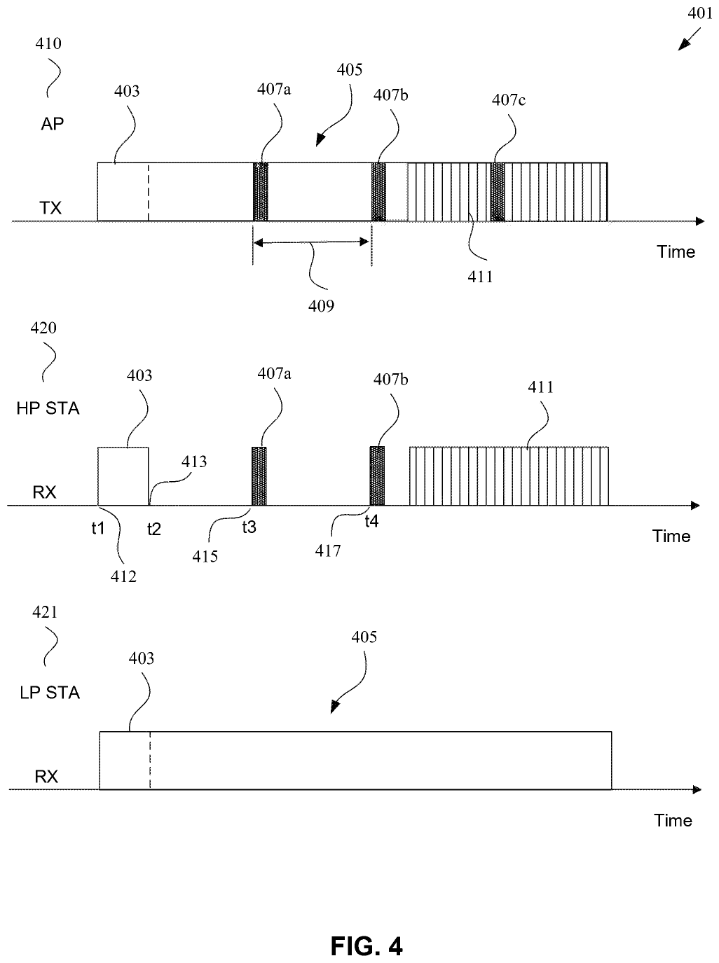

FIG. 4 illustrates an example of communication between an AP, an HP STA, and an LP STA for the power consumption mitigation techniques for the DL transmission of the HP packets using periodic overload marker symbols (OMSs), according to some aspects. As a convenience and not a limitation, FIG. 4 can be described with regard to elements of FIGS. 1-3.

FIG. 4 illustrates communication 401 between AP 410, the HP STA 420, and the LP STA 421. The AP 410 can be the AP 110 of FIG. 1. The HP STA 420 can be the HP STA 120b of FIG. 1. The LP STA 421 can be the LP STA 120a of FIG. 1. The AP 410 transmits one or more LP packets. The one or more LP packets can include preamble 403 and payload 405. According to some aspects, the preamble 403 and payload 405 can be addressed to the LP STA 421. However, the AP 410 can use the preamble 403 and payload 405 to transmit HP packet(s) to HP STAs such as the HP STA 420.

According to some aspects, the AP 410 can use the preamble 403 to indicate that the DL transmission of the LP packet(s) (e.g., the payload 405) can include DL transmission of HP packet(s). For example, the preamble 403 can include one or more signaling bits for indicating that the payload 405 can include DL transmission of HP packet(s). The AP 410 can set the one or more signaling bits to indicate that the payload 405 can include DL transmission of HP packet(s).

According to some aspects, the AP 410 can use one or more periodic OMSs 407a, 407b, and 407c (also referred to as the periodic OMS 407 or the periodic OMSs 407) to indicate whether the DL transmission of the LP packet(s) (e.g., the payload 405) is overloaded or preempted with HP packet(s) 411. The AP 410 can insert the periodic OMS 407 in the payload 405 to indicate whether HP packet(s) 411 will follow a respective periodic OMS 407. The periodic OMS 407 indicates presence/absence of an immediately following overloading/preempting event.

According to some aspects, the periodic OMSs 407 occur with a periodicity of OMS interval 409. According to some aspects, the value of the OMS interval 409 can be included in the preamble 403. Additionally, or alternatively, the AP 410 can communicate the value of the OMS interval 409 to the HP STA 420 during the connection establishment between the AP 410 and the HP STA 420. Additionally, or alternatively, the AP 410 can communicate the value of the OMS interval 409 to the HP STA 420 using one or more beacons. The value of the OMS interval 409 can be stored in a memory (e.g., the memory 250) of the HP STA 420. However, aspects of this disclosure are not limited to these examples, and the AP 410 can communicate the value of the OMS interval 409 to the HP STA 420 using other methods

As illustrated in FIG. 4, the AP 410 transmitting the payload 405 has no HP packet(s) to transmit after the periodic OMS 407a. Therefore, the periodic OMS 407a indicates that no HP packet(s) are transmitted in the OMS interval 409.

During the OMS interval 409, the AP 410 receives one or more HP packets. The AP 410 uses the periodic OMS 407b to indicate that HP packets are to be transmitted after the periodic OMS 407b. The AP 410 can wait for a given time period before transmitting the HP payload 411 (e.g., one or more HP packets). The given time period before transmitting the HP payload 411 can be zero or any predetermined time period. The given time period before transmitting the HP payload 411 can be predetermined based on the time needed for the HP STA 420 to transition its transceiver from the sleep state to the awake state. The given time period before transmitting the HP payload 411 can be communicated to the HP STA 420 during the communication between the AP 410 and the HP STA 420. The given time period before transmitting the HP payload 411 can be communicated to the HP STA 420 during the communication establishment between the AP 410 and the HP STA 420.

The HP STA 420 transitions its transceiver (e.g., a main radio) from the sleep state to the awake state at time t1 412 to receive the preamble 403. The HP STA 420 can detect, using the one or more signaling bits of the preamble 403, that the payload 405 can include HP packets. The HP STA 420 transitions its transceiver from the awake state to the sleep state at time t2 413 at the end of preamble 403. The HP STA 420 is aware of the OMS interval 409. The HP STA 420 can transition its transceiver (e.g., a main radio) from the sleep state to the awake state at time t3 415 and at time t4 417 to receive the periodic OMS 407a and OMS 407b, respectively.

After receiving the periodic OMS 407a, the HP STA 420 determines that no DL HP transmission will occur during the OMS interval 409. Therefore, the HP STA 420 transitions its transceiver to the sleep state after the periodic OMS 407a. However, after receiving the periodic OMS 407b, the HP STA 420 determines that DL HP transmission (e.g., the HP payload 411) will occur after the periodic OMS 407b. The periodic OMS 407b can indicate that the HP payload 411 will follow the periodic OMS 407b. For example, the periodic OMS 407b can include one or more signaling bits that can be set to indicate that the HP payload 411 will follow the periodic OMS 407b. The periodic OMS 407b can also indicate an identifier (e.g., an address) of the HP STA 420 to which the HP payload 411 is addressed. Therefore, the HP STA 420 maintains its transceiver in the awake state after the periodic OMS 407b to receive the DL HP transmission (e.g., the HP payload 411). The HP STA 420 can transition its transceiver to the sleep state after the HP STA 420 receives the HP payload 411 (e.g., one or more HP packets). According to some aspects, the HP STA 420 can ignore the periodic OMS 407b that the HP STA 420 receives during the reception of the HP payload 411.

As illustrated in FIG. 4, the LP STA 421 can receive and detect the preamble 403 and part of the payload 405 that include LP payload (e.g., one or more LP packets). In other words, the LP STA 421 will ignore the HP payload 411 that is destined for the HP STA 420.

According to some aspects, the periodic OMS 407 can include a high efficiency (HE) data symbol. The periodic OMS 407 can be transmitted on the resource unit (RU) on which the overload or preempt is occurring. In some implementations, the modulation coding technique (MCS) for the periodic OMS 407 can be predefined. In a non-limiting example, the MCS for the periodic OMS 407 can be MSC0. The periodic OMS 407 can include one or more signaling bits that can be set to indicate that the HP payload will follow the periodic OMS 407. The periodic OMS 407 can also indicate the identifier (e.g., an address) of the HP STA 420 to which the HP payload 411 is addressed. In a non-limiting example, the identifier (e.g., an address) of the HP STA 420 can be 12 bits. In some implementations, Wi-Fi™ 6/7 STAs on other RUs in the overloaded multi user (MU) PPDU(s) are allowed.

According to some aspects, the periodic OMS 407 can be a pre-defined waveform (e.g., a HE long training field (LTF) (HE-LTF) complement). In some implementations, the periodic OMS 407 can be transmitted on, for example, each 20 MHz sub channel of an overloaded MU PPDU. In some examples, STAs on other RUs in the overloaded MU PPDU are Wi-Fi™ 8 STAs. The periodic OMS 407 can include one or more signaling bits that can be set to indicate that the HP payload will follow the periodic OMS 407.

However, aspects of this disclosure are not limited to these examples, and other symbols can be used for the periodic OMS 407.

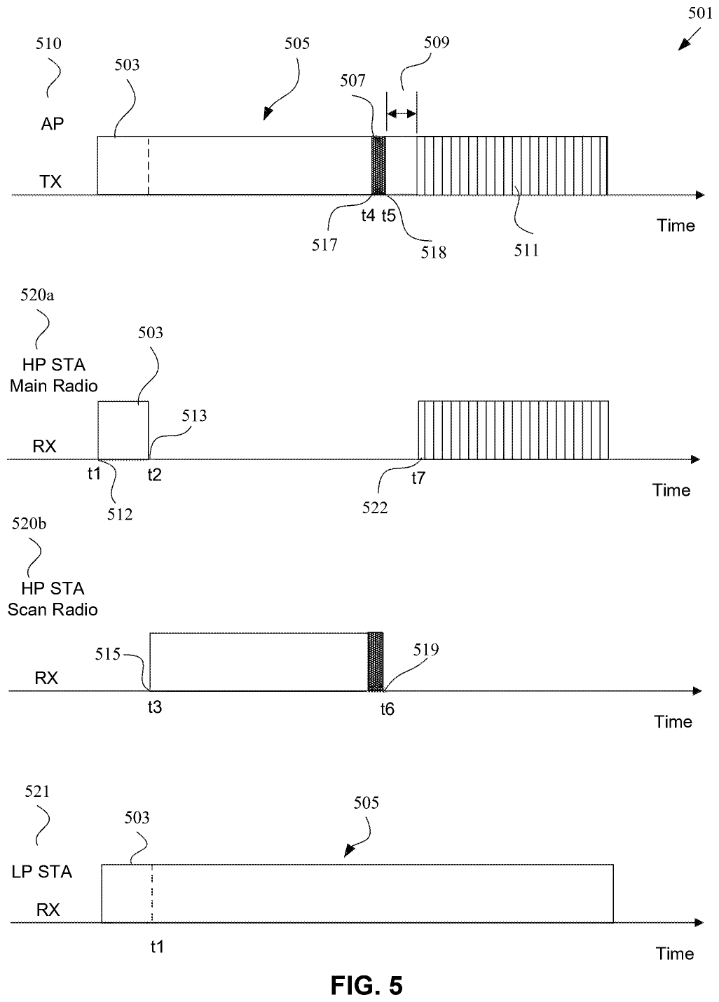

FIG. 5 illustrates an example of communication between an AP, an HP STA, and an LP STA for the power consumption mitigation techniques for the DL transmission of the HP packets using opportunistic overload marker symbols (OMSs), according to some aspects. As a convenience and not a limitation, FIG. 5 can be described with regard to elements of FIGS. 1-4.

FIG. 5 illustrates communication 501 between AP 510, the HP STA 520's radios 520a and 520b, and the LP STA 521. The AP 510 can be the AP 110 of FIG. 1. The LP STA 521 can be the LP STA 120a of FIG. 1. The HP STA 520 of FIG. 5 (which can be the HP STA 120b of FIG. 1) can have a transceiver (e.g., a main radio) 520a and a receive-only receiver (e.g., a scan radio) 520b. According to some aspects, the HP STA transceiver 520a can include transceiver 220a-220n of FIG. 2. The HP STA receive-only receiver 520b can include receive-only receiver 221 of FIG. 2.

The AP 510 transmits one or more LP packets. The one or more LP packets can include preamble 503 and payload 505. According to some aspects, the preamble 503 and payload 505 can be addressed to the LP STA 521. However, the AP 510 can use the preamble 503 and payload 505 to transmit HP packet(s) to HP STAs such as the HP STA 520 having radios 520a and 520b.

According to some aspects, the AP 510 can use the preamble 503 to indicate that the DL transmission of the LP packet(s) (e.g., the payload 505) can include DL transmission of HP packet(s). For example, the preamble 503 can include one or more signaling bits for indicating that the payload 505 can include DL transmission of HP packet(s). The AP 510 can set the one or more signaling bits to indicate that the payload 505 can include DL transmission of HP packet(s).

The HP STA 520 transitions its transceiver 520a (e.g., a main radio) from the sleep state to the awake state at time t1 512 to receive the preamble 503. The HP STA can detect, using the one or more signaling bits of the preamble 503, that the payload 505 can include HP packets. The HP STA 520 transitions its transceiver 520a from the awake state to the sleep state at time t2 513 at the end of preamble 503. The HP STA 520 then transitions its receive-only receiver 520b (e.g., a scan radio) from the sleep state to the awake state at time t3 515. According to some aspects, time t2 513 is the same as time t3 515. Additionally, or alternatively, time t3 515 can be after (or before) time t2 513. The HP STA 520 puts its receive-only receiver 520b on the RU assigned to the preamble 503 and the payload 505.

Instead of transitioning the receive-only receiver 520b from sleep state to the awake state, the HP STA 520 can switch, at time t3 515, the channel/RU that the receive-only receiver 520b is scanning at time t3 515 such that the receive-only receiver 520b can scan the channel/RU on which the payload 505 is transmitted. For example, after detecting the preamble 503, the HP STA 520 can tune its receive-only receiver 520b to the channel/RU on which the payload 505 is transmitted. Using its receive-only receiver 520b, the HP STA 520 can detect when the payload 505 includes any opportunistic OMSs 507.

The AP 510 can use one or more opportunistic OMSs 507 to indicate whether the DL transmission of the LP packet(s) (e.g., payload 505) is overloaded or preempted with HP packets (e.g., the HP payload 511). For example, the AP 510 can insert the opportunistic OMS 507 in the payload 505 to indicate that the HP payload 511 will follow the opportunistic OMS 507. The AP 510 receives the HP packets (to be transmitted to the HP STA 520) before time t4 517. After receiving the HP packets (to be transmitted to the HP STA 520), the AP 510 inserts the opportunistic OMS 507 in the payload 505 before the overload/preempt event is about to occur. In other words, the AP 510 inserts the opportunistic OMS 507 in the payload 505 before the HP payload 511 is to be overloaded/preempted to the payload 505. The opportunistic OMS 507 can include one or more signaling bits that can be set to indicate that the HP payload 511 will follow the periodic OMS 507. Additionally, or alternatively, the mere presence of the opportunistic OMS 507 can indicate that the HP payload 511 will follow the periodic OMS 507.

According to some aspects, the HP payload 511 is transmitted after a delay 509 after the transmission of the opportunistic OMS 507. For example, the delay 509 is between time t5 518 (when the transmission of the opportunistic OMS 507 is finished) and the time when the transmission of the HP payload 511 is started. The delay 509 can give time to the HP STA 520 to transition its transceiver 520a from the sleep state to the awake state.

The HP STA 520 can receive and detect the opportunistic OMS 507. By detecting the opportunistic OMS 507, the HP STA 520 can determine that the HP payload 511 is about to begin. The HP STA 520 can also detect its identifier from the opportunistic OMS 507. Therefore, the HP STA 520 determines that the upcoming HP payload 511 is addressed to the HP STA 520. After receiving the opportunistic OMS 507, the HP STA 520 can transition its receive-only receiver 520b to the sleep state at time t6 519. Alternatively, the HP STA 520 can switch its receive-only receiver 520b to scan other channels/RUs at time t6 519. In some implementations, time t6 519 is the same as time t5 518. Alternatively, time t6 519 is after time t5 518.

The HP STA 520 can further transition its transceiver 520a from the sleep state to the awake state at time t7 522. According to some aspects, time t7 522 is after a delay 509 after time t5 518 and/or time t6 519. Using its transceiver 520a, the HP STA 520 can receive the HP payload 511. After the HP STA 520 receives the HP payload 511, the HP STA 520 can transition its transceiver 520a to sleep state. Also, after the HP STA 520 receives the HP payload 511, the HP STA 520 can transition its receive-only receiver 520b to the awake state or the HP STA 520 can transition its receive-only receiver 520b to scan the channel/RU of the preamble 503/payload 505.

As illustrated in FIG. 5, the LP STA 521 can receive and detect the preamble 503 and part of the payload 505 that include LP payload (e.g., one or more LP packets). In other words, the LP STA 521 will ignore the HP payload 511 that is destined for the HP STA 520. According to some examples, the HP STA 520 can be a Wi-Fi™ 8 STA and the LP STA can be a Wi-Fi™ 6/7/8 STA.

According to some aspects, the opportunistic OMS 507 can have a legacy PPDU-based design such that the HP STA receive-only receiver 520b can be able to receive and detect the opportunistic OMS 507. The HP STA receive-only receiver 520b is configured to use the opportunistic OMS 507 to perform adaptive gain control (AGC), channel estimation, and timing acquisition using short training field (STF) and long training field (LTF).

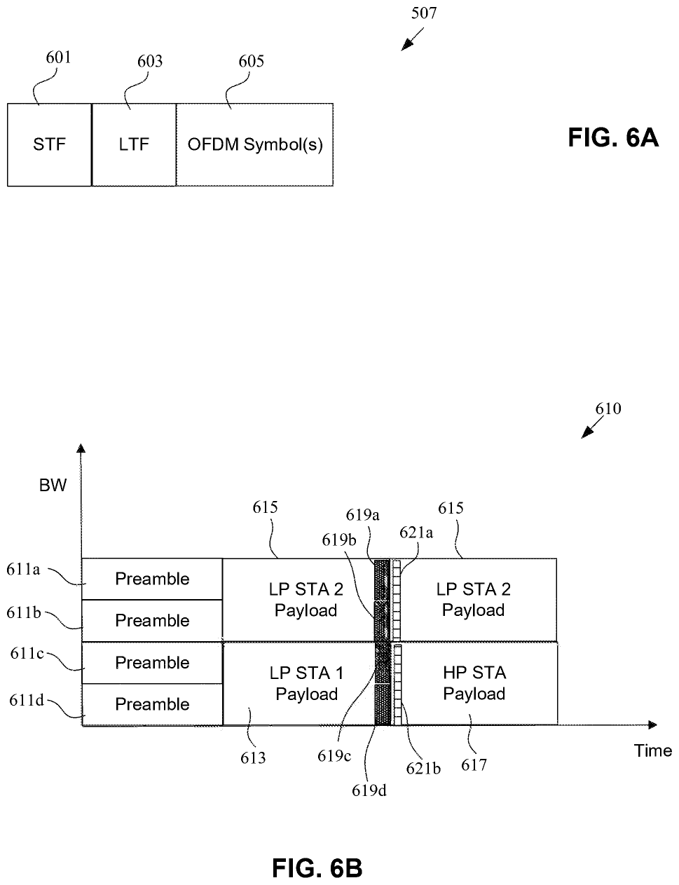

FIG. 6A illustrates an example design of the opportunistic OMS 507, according to some aspects. The opportunistic OMS 507 can include a STF field 601, a LTF field 603, and one or more orthogonal frequency-division multiplexing (OFDM) symbols 605. The STF field 601 and/or the LTF field 603 include information that allow/assist the HP STA 520 to detect the opportunistic OMS 507, perform frequency offset estimation, timing synchronization, or the like. In some implementations, the OFDM symbol 605 can include 1 OFDM symbol. The OFDM symbol 605 can be modulated using binary phase-shift keying (BPSK) code rate 1/2, according to some non-limiting examples. The OFDM symbol 605 can include 24 bits of information. A portion of the OFDM symbol 605 (e.g., 12 bits) can be used to identify the destination STA ID of the HP STA 520. The opportunistic OMS 507 can include one or more signaling bits that can be set to indicate that the HP payload 511 will follow the periodic OMS 507. Additionally, or alternatively, the mere presence of the opportunistic OMS 507 can indicate that the HP payload 511 will follow the periodic OMS 507.

FIG. 6B illustrates an example design of a multi user (MU) Physical Layer Protocol Data Unit (PPDU) with opportunistic OMS 610, according to some aspects of the disclosure. The MU PPDU with opportunistic OMS 610 includes preambles 611a-611d that are spread in the frequency. In some examples, each preamble 611 can have a bandwidth of 20 MHz. However, aspects of this disclosure are not limited to these examples and the preambles 611a-611d can have other bandwidths.

The MU PPDU with opportunistic OMS 610 can include an LP payload for a first LP STA that is overloaded/preempted by an HP payload. The MU PPDU with opportunistic OMS 610 can also include an LP payload for a second LP STA that is not overloaded/preempted by an HP payload. For example, the MU PPDU with opportunistic OMS 610 can include payload 613 for a first LP STA, payload 615 for a second LP STA, and payload 617 for an HP STA. The payload 613 can be an LP payload for the first LP STA that is overloaded/preempted by the payload 617 that is an HP payload. The payload 615 can be an LP payload for the second LP STA that is not overloaded/preempted by an HP payload.

According to some aspects, the preamble 611d and/or the preamble 611c for the first LP STA can include information indicating that the overload/preempt can occur in the payload 613, as discussed above.

The MU PPDU with opportunistic OMS 610 can also include opportunistic OMSs 619a-619d. The opportunistic OMSs 619c and/or 619d can indicate that the HP payload 617 is to be transmitted after the opportunistic OMSs 619c and/or 619d. In a non-limiting example, each of the opportunistic OMSs 619a-619d can have a bandwidth of 20 MHz. However, aspects of this disclosure are not limited to this example and the opportunistic OMSs 619a-619d can have other durations and bandwidths.

The MU PPDU with opportunistic OMS 610 can also include guard intervals 621a and 621b. According to some aspects, for the duration of each of the opportunistic OMSs 619a-619d to be same as (equals to) a HE data symbol to avoid OFDM symbol boundary misalignment at other STAs on other RUs, the opportunistic OMSs 619a-619d are appended with the guard intervals 621a and 621b. For example, the AP can append the opportunistic OMSs 619a-619d with the guard intervals 621a and 621b.

In a non-limiting example, each of the guard intervals 621a and 621b can have a multiple (e.g., n) of 0.8μ s (e.g., n x 0.8μ s) duration in time. Also, each of the guard intervals 621a and 621b can have a bandwidth of 40 MHz. However, aspects of this disclosure are not limited to this example and the guard intervals 621a and 621b can have other durations and bandwidths.

In a non-limiting example, the duration (in time) of each of the guard intervals 621a and 621b with the duration (in time) of each of the opportunistic OMSs 619a-619d can be the same as (equals to) the duration (in time) of the HE data symbol (e.g., a data OFDM symbol). In a non-limiting example, this duration of the HE data symbol can be, but is not limited to, 13.6 μs.

According to some aspects, the second LP STA is capable of detecting occurrence of the opportunistic OMSs 619a and 619b (e.g., a packet detector of the second LP STA is always running in the background) to avoid mistakes in receiving the rest of the payload 615 that is after the opportunistic OMSs 619a and 619b.

Although FIG. 6B is discussed with respect to the MU PPDU with opportunistic OMS 610, aspects of this disclosure can be applied to MU PPDU with periodic OMS and/or MU PPDU with timeout period. Aspects of this disclosure discussed herein (e.g., FIGS. 1-8) can be applied to MU PPDU.

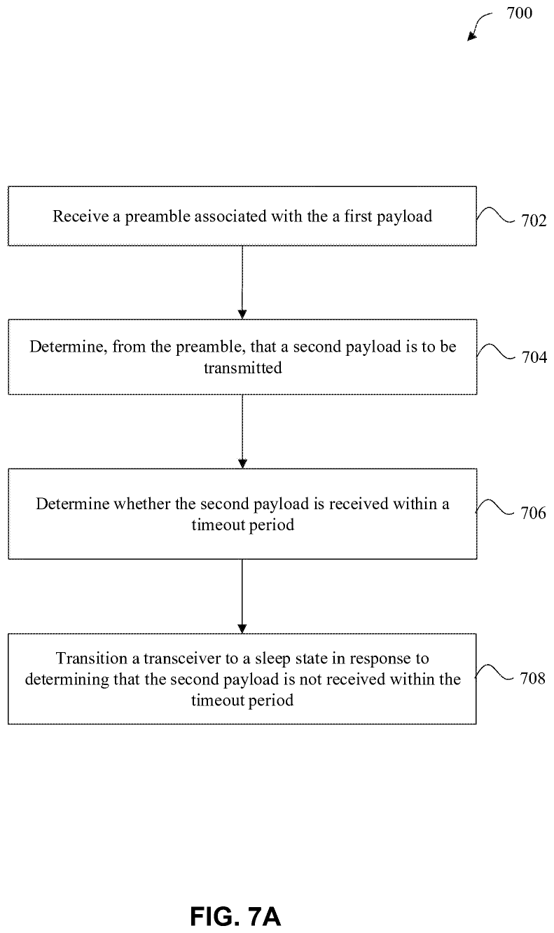

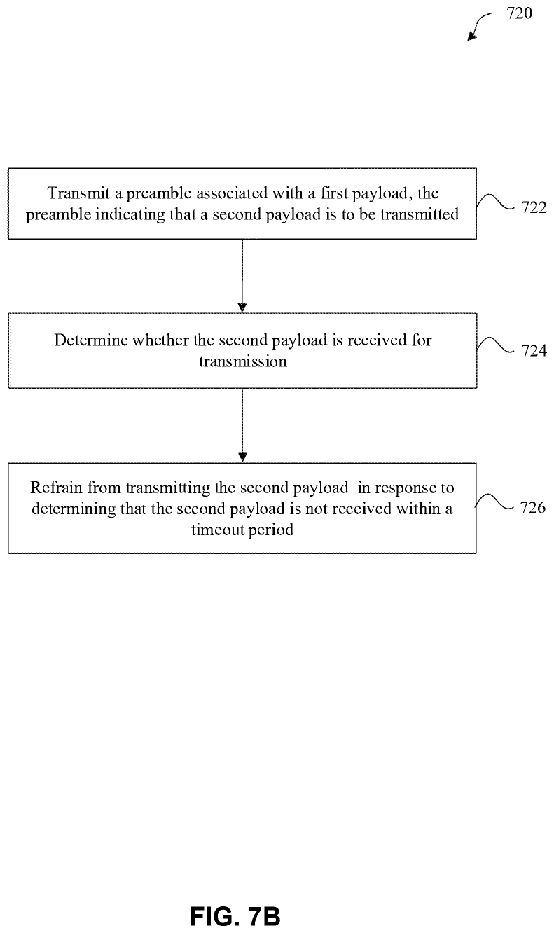

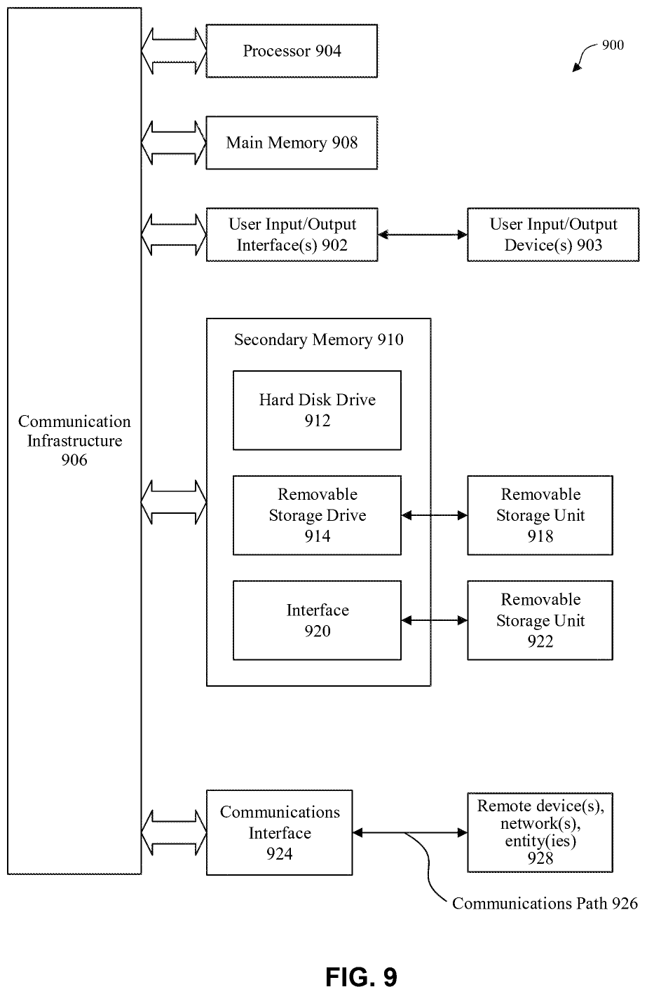

FIG. 7A illustrates an example method 700 for a wireless system supporting and implementing the power consumption mitigation techniques for the DL transmission of HP packets using a timeout period, according to some aspects. As a convenience and not a limitation, FIG. 7A can be described with regard to elements of FIGS. 1-6. Method 700 can represent the operation of an electronic device (e.g., an HP STA as discussed in this disclosure) implementing the power consumption mitigation techniques using a timeout period. Method 700 can also be performed by device 200 of FIG. 2 and/or computer system 900 of FIG. 9. But method 700 is not limited to the specific aspects depicted in those figures and other systems can be used to perform the method as will be understood by those skilled in the art. It is to be appreciated that not all operations can be needed, and the operations cannot be performed in the same order as shown in FIG. 7A.

According to some aspects, method 700 can represent the operation of the HP STA as discussed with respect to FIG. 3.

At 702, a preamble associated with a first payload is received. For example, the HP STA can receive, using its transceiver and from an AP, the preamble associated with the first payload. The first payload can include an LP payload (e.g., one or more LP packets). The HP STA can transition its transceiver from a sleep state to an awake state before receiving the preamble.

At 704, it is determined that a second payload is to be transmitted. For example, the HP STA can determine, based at least on the preamble, that the second payload is to be received by the HP STA (e.g., to be transmitted by the AP.) The second payload can include an HP payload (e.g., one or more HP packets). For example, the preamble can include one or more signaling bits for indicating that the first payload can include DL transmission of the second payload. Using the signaling bits in the preamble, the HP STA can determine that the second payload can be transmitted by the AP.

At 706, it is determined whether the second payload is received within a timeout period. For example, the HP STA can determine whether the second payload is received within the timeout period. In some implementations, the HP STA can start a timer when the HP STA receives the preamble. The HP STA can compare the value of the timer with the timeout period. Using the value of the timer and the timeout period, the HP STA can determine whether the second payload is received within the timeout period.

At 708, in response to determining that the second payload is not received within the timeout period, the transceiver is transitioned to the sleep state. For example, the HP STA can transition its transceiver to the sleep state (e.g., a lower power state than the awake state) when the HP STA does not receive the second payload within the timeout period.

However, when the HP STA receives the second payload within the timeout period, the HP STA can maintain its transceiver in the awake state until the HP STA receives the second payload. After receiving the second payload, the HP STA can transition its transceiver to the sleep state.

FIG. 7B illustrates an example method 720 for a wireless system supporting and implementing the power consumption mitigation techniques for the DL transmission of HP packets using a timeout period, according to some aspects. As a convenience and not a limitation, FIG. 7B can be described with regard to elements of FIGS. 1-6. Method 720 can represent the operation of an electronic device (e.g., an AP as discussed in this disclosure) implementing the power consumption mitigation techniques using a timeout period. Method 720 can also be performed by device 200 of FIG. 2 and/or computer system 900 of FIG. 9. But method 720 is not limited to the specific aspects depicted in those figures and other systems can be used to perform the method as will be understood by those skilled in the art. It is to be appreciated that not all operations can be needed, and the operations cannot be performed in the same order as shown in FIG. 7B.

According to some aspects, method 700 can represent the operation of the AP as discussed with respect to FIG. 3.

At 722, a preamble associated with a first payload is transmitted. For example, an AP can transmit the preamble associated with the first payload to one or more HP STAs and/or one or more LP STAs. The first payload can include an LP payload (e.g., one or more LP packets). The preamble can indicate that a second payload is to be transmitted. The second payload can include an HP payload (e.g., one or more HP packets). For example, the preamble can include one or more signaling bits for indicating that the first payload can include DL transmission of the second payload. Using the signaling bits in the preamble, the HP STA can determine that the second payload can be transmitted by the AP.

At 724, it is determined whether the second payload is received for transmission. For example, the AP can determine whether the AP has receive the second payload for transmitting to the HP STA. The AP can receive the second payload from another STA for transmitting to the HP STA.

At 726, in response to determining that the second payload is not received within a timeout period, the second payload is not transmitted. For example, the AP can refrain from transmitting the second payload in response to determining that the second payload is not received within the timeout period. However, the AP can transmit the second payload to the HP STA in response to determining that the second payload is received within the timeout period.

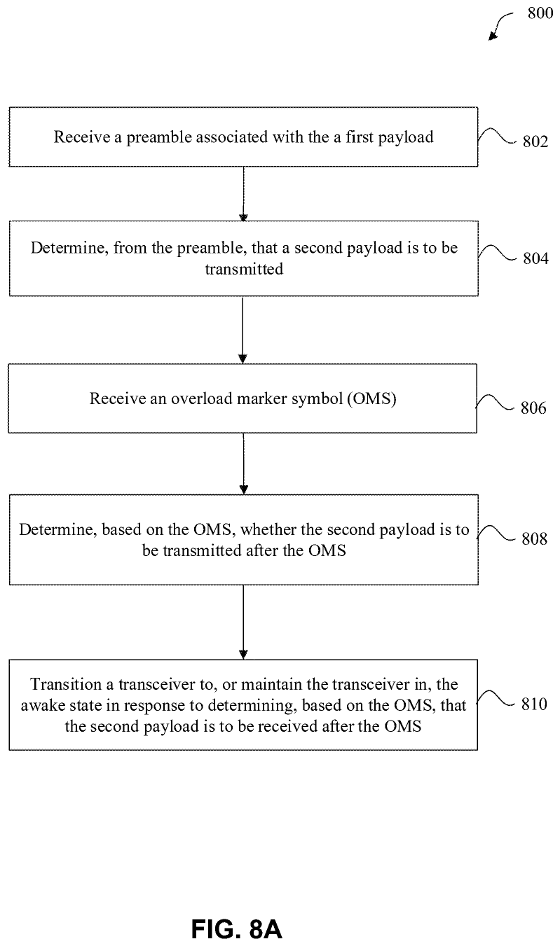

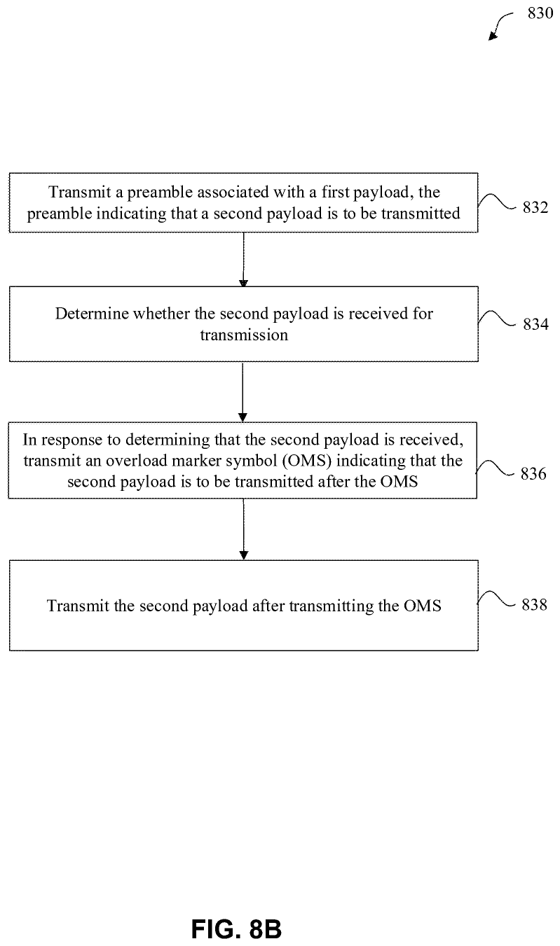

FIG. 8A illustrates an example method 800 for a wireless system supporting and implementing the power consumption mitigation techniques for the DL transmission of the HP packets using overload marker symbols (OMSs), according to some aspects. As a convenience and not a limitation, FIG. 8A can be described with regard to elements of FIGS. 1-7. Method 800 can represent the operation of an electronic device (e.g., an HP STA as discussed in this disclosure) implementing the power consumption mitigation techniques using OMS. Method 800 can also be performed by device 200 of FIG. 2 and/or computer system 900 of FIG. 9. But method 800 is not limited to the specific aspects depicted in those figures and other systems can be used to perform the method as will be understood by those skilled in the art. It is to be appreciated that not all operations can be needed, and the operations cannot be performed in the same order as shown in FIG. 8A.

According to some aspects, method 800 can represent the operation of the HP STA as discussed with respect to FIGS. 4-5.

At 802, a preamble associated with a first payload is received. For example, the HP STA can receive (using an HP STA transceiver) the preamble associated with the first payload from an AP. The first payload can include an LP payload (e.g., one or more LP packets). According to some aspects, the HP STA transitions its transceiver from a sleep state to an awake state before receiving the preamble. The HP STA then transitions its transceiver from the awake state to the sleep state after receiving the preamble.

At 804, it is determined, based at least on the preamble, that a second payload is to be received by the HP STA (e.g., to be transmitted by the AP). For example, similar to operation 704 discussed above, the HP STA can determine, using the preamble, that the second payload is to be received by the HP STA (e.g., to be transmitted by the AP).

At 806, an overload marker symbol (OMS) is received. For example, the HP STA can receive one or more OMSs. As discussed above, for example, with respect to FIG. 4, the OMS can be one symbol in a plurality of periodic OMSs. Additionally, or alternatively, as discussed above, for example, with respect to FIG. 5, the OMS can be an opportunistic OMS.

At 808, it is determined, based at least on the OMS, whether the second payload is to be received after (e.g., following) the OMS. For example, the OMS can indicate whether the AP is transmitting the second payload after the OMS.

At 810, the transceiver is transitioned to, or is maintained in, the awake state in response to determining, using the OMS, that the second payload is to be received after the OMS. For example, the HP STA can transition (or maintain) its transceiver to (or in) the awake state in response to determining, using the OMS, that the second payload is to be received after the OMS. For example, the HP STA can operate its transceiver in the awake state in response to determining, using the OMS, that the second payload is to be received following the OMS.

In some implementations, the OMS is one symbol in a plurality of periodic OMSs. Operation 806 can further include determining an OMS interval between two consecutive OMSs in the plurality of periodic OMSs and transitioning the HP STA transceiver from the sleep state to the awake state before each occurrence of the plurality of periodic OMSs. The HP STA can receive the OMS on its transceiver. The HP STA maintains its transceiver in the awake state in response to determining that the second payload is to be received after the OMS. The HP STA can receive the second payload using its transceiver. The HP STA then transitions the transceiver to the sleep state after receiving the second payload.

In some implementations, the OMS is an opportunistic OMS. Operation 806 can further include transitioning a receive-only receiver of the HP STA to the awake state and receiving, using the receive-only receiver, the opportunistic OMS. The HP STA can then transition its transceiver from the sleep state to the awake state in response to determining that the second payload is to be received after the opportunistic OMS. The HP STA can receive the second payload using its transceiver. The HP STA can then transition its transceiver to the sleep state after receiving the second payload. The HP STA can also transition the receive-only receiver to the sleep state after receiving the opportunistic OMS.

FIG. 8B illustrates an example method 830 for a wireless system supporting and implementing the power consumption mitigation techniques for the DL transmission of the HP packets using overload marker symbols (OMSs), according to some aspects. As a convenience and not a limitation, FIG. 8B can be described with regard to elements of FIGS. 1-7. Method 830 can represent the operation of an electronic device (e.g., an AP as discussed in this disclosure) implementing the power consumption mitigation techniques using OMS. Method 830 can also be performed by device 200 of FIG. 2 and/or computer system 900 of FIG. 9. But method 830 is not limited to the specific aspects depicted in those figures and other systems can be used to perform the method as will be understood by those skilled in the art. It is to be appreciated that not all operations can be needed, and the operations can not be performed in the same order as shown in FIG. 8B.

According to some aspects, method 830 can represent the operation of the AP as discussed with respect to FIGS. 4-5.

At 832, a preamble associated with a first payload is transmitted. For example, the AP can transmit the preamble associated with the first payload. The first payload can include an LP payload (e.g., one or more LP packets). The AP can transmit the first payload to an LP STA. The AP can use the first payload to later transmit a second payload (e.g., an HP payload) to an HP STA. The preamble can indicate that the second payload is to be transmitted. For example, the preamble can include one or more signaling bits for indicating that the first payload can include DL transmission of the second payload. The AP can set the one or more signaling bits for indicating that the first payload can include DL transmission of the second payload.

At 834, it is determined whether the second payload is received for transmission. For example, the AP can determine whether the AP has received the second payload that the AP will transmit to the HP STA. The AP can receive the second payload from another STA for transmitting to the HP STA.

At 836, in response to determining that the second payload is received, an overload marker symbol (OMS) is transmitted. For example, the AP can transmit one or more OMSs in response to determining that the second payload is received at the AP. The OMS can indicate that the second payload is to be transmitted after the OMS. As discussed above, for example, with respect to FIG. 4, the OMS can be one symbol in a plurality of periodic OMSs. Additionally, or alternatively, as discussed above, for example, with respect to FIG. 5, the OMS can be an opportunistic OMS.

With respect to the periodic OMS, the AP can signal in the next occurrence of the periodic OMS to the HP STA that the second payload is to be transmitted after the periodic OMS. In some examples, the AP can set one or more signaling bits in the periodic OMS to signal to the HP STA that the second payload is to be transmitted after the periodic OMS.

With respect to the opportunistic OMS, the AP can generate and transmit the opportunistic OMS after the AP receives the second payload. In some implementations, the opportunistic OMS signals to the HP STA that the second payload is to be transmitted after the opportunistic OMS. In some implementations, the AP can set one or more signaling bits in the opportunistic OMS to signal to the HP STA that the second payload is to be transmitted after the opportunistic OMS.

At 838, the second payload is transmitted after transmitting the OMS. For example, the AP can transmit the second payload after the AP transmits the OMS.

Various aspects can be implemented, for example, using one or more computer systems, such as computer system 900 shown in FIG. 9. Computer system 900 can be any computer capable of performing the functions described herein such as devices 110, 120 of FIG. 1 or 200 of FIG. 2. Computer system 900 includes one or more processors (also called central processing units, or CPUs), such as a processor 904. Processor 904 is connected to a communication infrastructure 906 (e.g., a bus.) Computer system 900 also includes user input/output device(s) 903, such as monitors, keyboards, pointing devices, etc., that communicate with communication infrastructure 906 through user input/output interface(s) 902. Computer system 900 also includes a main or primary memory 908, such as random access memory (RAM). Main memory 908 can include one or more levels of cache. Main memory 908 has stored therein control logic (e.g., computer software) and/or data.

Computer system 900 can also include one or more secondary storage devices or memory 910. Secondary memory 910 can include, for example, a hard disk drive 912 and/or a removable storage device or drive 914. Removable storage drive 914 can be a floppy disk drive, a magnetic tape drive, a compact disk drive, an optical storage device, tape backup device, and/or any other storage device/drive.

Removable storage drive 914 can interact with a removable storage unit 918. Removable storage unit 918 includes a computer usable or readable storage device having stored thereon computer software (control logic) and/or data. Removable storage unit 918 can be a floppy disk, magnetic tape, compact disk, DVD, optical storage disk, and/any other computer data storage device. Removable storage drive 914 reads from and/or writes to removable storage unit 918 in a well-known manner.

According to some aspects, secondary memory 910 can include other means, instrumentalities or other approaches for allowing computer programs and/or other instructions and/or data to be accessed by computer system 900. Such means, instrumentalities or other approaches can include, for example, a removable storage unit 922 and an interface 920. Examples of the removable storage unit 922 and the interface 920 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 can further include a communication or network interface 924. Communication interface 924 enables computer system 900 to communicate and interact with any combination of remote devices, remote networks, remote entities, etc. (individually and collectively referenced by reference number 928). For example, communication interface 924 can allow computer system 900 to communicate with remote devices 928 over communications path 926, which can be wired and/or wireless, and which can include any combination of LANs, WANs, the Internet, etc. Control logic and/or data can be transmitted to and from computer system 900 via communication path 926.

The operations in the preceding aspects can be implemented in a wide variety of configurations and architectures. Therefore, some or all of the operations in the preceding aspects can be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 900, main memory 908, secondary memory 910 and removable storage units 918 and 922, as well as tangible articles of manufacture embodying any combination of the foregoing. Such control logic, when executed by one or more data processing devices (such as computer system 900), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 9. In particular, aspects can operate with software, hardware, and/or operating system implementations other than those described herein.

It is to be appreciated that the Detailed Description section, and not the Summary and Abstract sections, is intended to be used to interpret the claims. The Summary and Abstract sections can set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “an aspect,” “some aspects,” “an example,” “some examples” or similar phrases, indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

As described above, aspects of the present technology may include the gathering and use of data available from various sources, e.g., to improve or enhance functionality. The present disclosure contemplates that in some instances, this gathered data may include personal information data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital signs measurements, medication information, exercise information), date of birth, or any other identifying or personal information. The present disclosure recognizes that the use of such personal information data, in the present technology, may be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology may be configurable to allow users to selectively “opt in” or “opt out” of participation in the collection of personal information data, e.g., during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure may broadly cover use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. An electronic device, comprising:
a transceiver configured to communicate using a wireless network; and
a processor communicatively coupled with the transceiver and configured to:
receive, using the transceiver and from a second electronic device, a preamble associated with a first payload;
determine, based at least on the preamble, that a second payload is to be received;
receive, from the second electronic device, an overload marker symbol (OMS);
determine, based at least on the OMS, whether the second payload is to be received following the OMS; and
operate the transceiver in an awake state in response to determining that the second payload is to be received following the OMS.

2. The electronic device of claim 1, wherein the OMS comprises an identifier of the electronic device.

3. The electronic device of claim 1, wherein the processor is further configured to:
transition the transceiver to a lower power state than the awake state after receiving the preamble.

4. The electronic device of claim 3, wherein the OMS is one symbol in a plurality of periodic OMSs and the processor is further configured to:
determine an OMS interval between two consecutive OMSs in the plurality of periodic OMSs; and
transition the transceiver from the lower power state to the awake state before the next occurrence of an OMS of the plurality of periodic OMSs.

5. The electronic device of claim 4, wherein operating the transceiver in the awake state further comprises:
maintaining the transceiver in the awake state in response to determining that the second payload is to be received after the OMS; and
transitioning the transceiver to the lower power state after receiving the second payload.

6. The electronic device of claim 3, wherein the OMS is an opportunistic OMS and, to receive the opportunistic OMS, the processor is further configured to:
transition a receive-only receiver of the electronic device to an awake state; and
receive, using the receive-only receiver, the opportunistic OMS.

7. The electronic device of claim 6, wherein the processor is further configured to:
transition the transceiver from the lower power state to the awake state in response to determining that the second payload is to be received after the opportunistic OMS; and
transition the transceiver to the lower power state after receiving the second payload.

8. The electronic device of claim 6, wherein the processor is further configured to:
transition the receive-only receiver to a lower power state after receiving the opportunistic OMS.

9. The electronic device of claim 6, wherein the opportunistic OMS comprises an identifier of the electronic device.

10. The electronic device of claim 6, wherein a duration of the opportunistic OMS equals a duration of a high efficiency (HE) data symbol.

11. A method, comprising:
receiving, using a transceiver of a first electronic device and from a second electronic device, a preamble associated with a first payload;
determining, based at least on the preamble, that a second payload is to be received;
receiving, from the second electronic device, an overload marker symbol (OMS);
determining, based at least on the OMS, whether the second payload is to be received following the OMS;
operating the transceiver in an awake state in response to determining, using the OMS, that the second payload is to be received following the OMS; and
receiving, using the transceiver, the second payload.

12. The method of claim 11, further comprising:
transitioning the transceiver to a lower power state than the awake state after receiving the preamble.

13. The method of claim 12, wherein the OMS is one symbol in a plurality of periodic OMSs and the method further comprising:
determining an OMS interval between two consecutive OMSs in the plurality of periodic OMSs; and
transitioning the transceiver from the lower power state to the awake state before the next occurrence of an OMS of the plurality of periodic OMSs.

14. The method of claim 13, wherein operating the transceiver in the awake state further comprising:
maintaining the transceiver in the awake state in response to determining that the second payload is to be received after the OMS; and
transitioning the transceiver to the lower power state after receiving the second payload.

15. The method of claim 12, wherein the OMS is an opportunistic OMS and receiving the opportunistic OMS comprises:
transitioning a receive-only receiver of the electronic device to an awake state; and
receiving, using the receive-only receiver, the opportunistic OMS.

16. The method of claim 15, further comprising:
transitioning the transceiver from the lower power state to the awake state in response to determining that the second payload is to be received after the opportunistic OMS; and
transitioning the transceiver to a lower power state after receiving the second payload.

17. The method of claim 15, further comprising:
transitioning the receive-only receiver to the lower power state after receiving the opportunistic OMS.

18. The method of claim 15, wherein a duration of the opportunistic OMS duration is same as a duration of a high efficiency (HE) data symbol.

19. The method of claim 11, wherein the OMS comprises an identifier of the electronic device.

20. An electronic device, comprising:
a transceiver configured to communicate using a wireless network; and
a processor communicatively coupled with the transceiver and configured to:
receive, using the transceiver and from a second electronic device, a preamble associated with a first payload;
determine, based at least on the preamble, that a second payload is to be received;
determine whether the second payload is received within a timeout period; and
transition the transceiver to a lower power state than an awake state in response to determining that the second payload is not received within the timeout period.
